(19) United States
(12) Patent Application Publication
(10) Pub. No.: US 2018/0075291 A1
(43) Pub. Date: Mar. 15, 2018

(54) BIOMETRICS AUTHENTICATION BASED ON A NORMALIZED IMAGE OF AN OBJECT

(71) Applicant: KABUSHIKI KAISHA TOSHIBA, Tokyo (JP)

(72) Inventors: Guifen TIAN, Yokohama Kanagawa (JP); Nobuhiro NONOGAKI, Taito Tokyo (JP)

(21) Appl. No.: 15/448,553

(22) Filed: Mar. 2, 2017

(30) Foreign Application Priority Data
Sep. 12, 2016 (JP) 2016-177861

(51) Int. Cl. G06K 9/00

(52) U.S. Cl. CPC G06K 9/00288; G06K 9/4671; G06K 9/00268

(57) ABSTRACT

A method for carrying out a biometrics authentication includes detecting an object from a first image including the object, detecting feature points of the object in the detected object, generating a second image based on the feature points, wherein the second image is a normalized image of the object that is obtained by rotating and resizing the object in the first image, determining whether or not the object in the second image faces front, calculating a feature value of the object upon determining that the object in the normalized image faces front, and comparing the calculated feature value with a reference feature value for the biometrics authentication.

### CROSS-REFERENCE TO RELATED APPLICATION

This application is based upon and claims the benefit of priority from Japanese Patent Application No. 2016-177861, filed Sep. 12, 2016, the entire contents of which are incorporated herein by reference.

### FIELD

Embodiments described herein relate generally to a method for carrying out biometrics authentication based on a normalized image of an object.

### BACKGROUND

According to related art, a face authentication device has been employed as one of biometrics authentication devices. The face authentication device of the related art performs a normalization process on an input image based on the feature points of a face detected from the input image. The normalization process is carried out to generate a normalized image in which an orientation of a face in the input image is modified so as to face front, and the size of the face is modified so as to have a certain size. The face authentication device of the related art uses the normalized image for face authentication in order to improve the authentication rate.

However, the normalized image obtained through the normalization process may not necessarily be appropriate for the face authentication, because the face in the normalized image may not necessary face front nor have the certain size, depending on the setting of the feature points.

### DESCRIPTION OF THE DRAWINGS

FIG. 1 is a block diagram of an authentication system according to a first embodiment.

FIG. 2 is a block diagram of a normalization evaluator in the authentication system according to the first embodiment.

FIG. 3 is a flowchart showing an example of the operation of the authentication system according to the first embodiment.

FIG. 4A schematically illustrates an example of calculation of a score (value) when a normalization process is determined to be appropriate during the operation of the authentication system according to the first embodiment, and FIG. 4B schematically illustrates an example of calculation of a score (value) when the normalization process is determined to be inappropriate.

FIG. 5 is a block diagram of a normalization evaluator in the authentication system according to a second embodiment.

FIG. 6 is a flowchart showing an example of the operation of the authentication system according to the second embodiment.

FIG. 7A schematically illustrates an example of the detection of a feature point when a normalization process is determined to be appropriate during the operation of the authentication system according to the second embodiment, and FIG. 7B schematically illustrates an example of the detection of a feature point when the normalization process is determined to be inappropriate.

FIG. 8 is a block diagram of an authentication system according to a third embodiment.

FIG. 9 is a flowchart showing an example of the operation of the authentication system according to the third embodiment.

FIG. 10 is a flowchart showing an example of the operation of the authentication system according to a variation of the third embodiment.

### DETAILED DESCRIPTION

An embodiment provides a feature value extraction device and an authentication system capable of properly authenticating an object.

In general, according to an embodiment, a method for carrying out a biometrics authentication includes detecting an object from a first image including the object, detecting feature points of the object in the detected object, generating a second image based on the feature points, wherein the second image is a normalized image of the object that is obtained by rotating and resizing the object in the first image, determining whether or not the object in the second image faces front, calculating a feature value of the object upon determining that the object in the normalized image faces front, and comparing the calculated feature value with a reference feature value for the biometrics authentication.

Embodiments of the present invention will be described below with reference to the accompanying drawings. In the following embodiments, the characteristic configuration and operation of a feature value extraction device will be mainly described, although the feature value extraction device there may have configurations and carry out operations, which are omitted in the following description. These omitted configuration and operation are also included in the scope of the present disclosure.

### First Embodiment

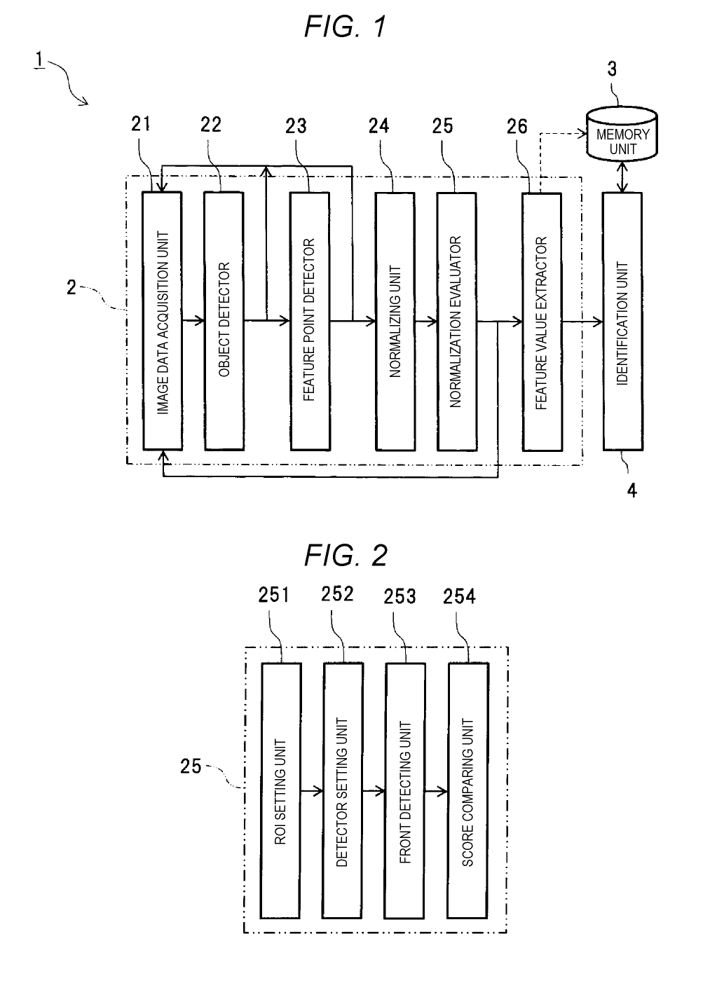

FIG. 1 is a block diagram of an authentication system 1 according to a first embodiment. The authentication system 1 of the first embodiment is used for authenticating a predetermined object (hereinafter, also referred to as an object) from an image taken by a camera, for example. The object may be a human face, for example. The authentication result of the object can be used for various security systems.

The authentication system 1 includes a feature value extraction device 2, a memory unit 3, and an identification unit 4. The feature value extraction device 2 includes an image data acquisition unit 21, an object detector 22, a feature point detector 23, a normalizing unit 24, a normalization evaluator 25, and a feature value extractor 26.

Each of the units 21 to 26 in the feature value extraction device 2 is hardware such as an arithmetic processing device and a storage device. Further, the authentication system 1 may be mounted on one device or facility, or may be partially mounted on a device (for example, a server or a database on the cloud), which is communicable via an external network.

The image data acquisition unit 21 acquires image data of an input image (first image) including an object, and outputs the acquired image data to the object detector 22. The image data acquisition unit 21 may be a device for inputting image data taken by a camera, or may be a device for acquiring image data by other methods.

The object detector 22 detects an object based on the image data. For example, the object detector 22 detects the position and size of the object from the luminance component of the image data. Specifically, the object detector 22 detects the object based on dictionary data (reference data). The dictionary data are stored in a storage region of the authentication system 1. A feature value indicating a characteristic according to the luminance component of the object in each image is stored in the dictionary data, based on a feature common to many objects, for example, as a result of learning of each of an image in which an object faces the front (hereinafter referred to as a front image), and an image in which an object faces obliquely (hereinafter referred to as an oblique image). The object detector 22 detects, as the object, an image having a feature value recorded in the dictionary data from the input image. Alternatively, the object detector 22 may provide the image having the predetermined size including a detected object as the detection result.

For example, a Joint-Haarlike feature value representing the intensity of the luminance gradient of a rectangular region is used as the feature value used for object detection. The Joint-Haarlike feature value is a scalar amount determined as a difference value of the average luminance of two adjacent rectangular regions based on co-occurrence of a plurality of Haarlike feature values. Since luminance value itself is not used for the Joint-Haarlike feature value, fluctuations in illumination conditions and the influence of noise may be reduced.

The object detector 22 outputs the image data of the detected object to the feature point detector 23. It is noted that, when no object can be detected, the object detector 22 notifies the image data acquisition unit 21 of failure of detection.

The feature point detector 23 detects a feature point of the object based on the image data of the object. For example, the feature point detector 23 uses a circular separability filter or a corner detection algorithm to detect the feature point of the object. The feature point detector 23 outputs the data of the detected feature point to the normalizing unit 24. It is noted that, when no feature point can be detected, the feature point detector 23 notifies the image data acquisition unit 21 of failure of detection.

The normalizing unit 24 normalizes the input image based on the feature point of the object and generates a normalized image. The term “normalized image” refers to an image in which the direction and size of the object are converted such that the object faces the front and has a predetermined size. For example, a three-dimensional shape model is used for normalization process. The three-dimensional shape model refers to data in which the shape of the object is expressed in three dimensions using a polarity of three dimensional points in (x, y, z) form, with the positions and depth of feature points known. The normalizing unit 24 may determine a transformation matrix allowing the input image to be transformed such that the square error with the feature points on three-dimensional shape model may be minimized to estimate the texture on the three-dimensional shape model from the input image. Then, the normalizing unit 24 may rotate the three-dimensional shape model and the texture to the front to generate the normalized image.

The normalizing unit 24 outputs the normalized image to the normalization evaluator 25. Performing the normalization process allows variations in the size and angle of the object to be reduced, thus, increasing an authentication rate.

The normalization evaluator 25 determines whether or not there is an object facing the front in the normalized image. In other words, the normalization evaluator 25 evaluates whether the normalized image is appropriate as an image used for authentication.

FIG. 2 is a block diagram of the normalization evaluator 25. The normalization evaluator 25 includes an ROI setting unit 251, a detector setting unit 252, a front detecting unit 253, and a score comparing unit 254.

The ROI setting unit 251 sets an ROI (region of interest) in which an object supposed to exist, in the normalized image. The normalized image is highly related to the detected positions of feature point. If feature points are not accurately detected, the “object” in the normalized image may be only partially visible or may be very small but are with unnecessary background. Generally, the ROI may be part or the whole of the region of the normalized image, dependent on detailed implementation in the normalizing unit 24. The ROI setting unit 251 outputs the data of the set ROI to the detector setting unit 252.

The detector setting unit 252 sets the maximum and minimum of the size of the object to be detected depending on the size of the ROI. The detector setting unit 252 may set the size of the object in pixels. The detector setting unit 252 outputs the size of the set object to the front detecting unit 253.

The front detecting unit 253 detects the front image of the object included in the normalized image, and calculates a score SC1 (first score, first value) indicating a likelihood that the object faces front. At this time, the front detecting unit 253 excludes an object having size larger than the size set by the detector setting unit 252 from a detection target. The score SC1 is a parameter indicating the likelihood that there is a front image in the normalized image. For example, the score SC1 has a larger value as the direction of the object is closer to the front. For example, the score SC1 correlates with the Joint-Haarlike feature value, and the value thereof increases as the Joint-Haarlike feature value increases. The front detecting unit 253 may detect the front image using the dictionary data. The front detecting unit 253 outputs the front image and the score SC1 to the score comparing unit 254. By calculating the score SC1, the front detecting unit 253 can detect the likelihood that the front image is the object facing the front.

The score comparing unit 254 compares the score SC1 with a threshold value T1 (first threshold value). The threshold value T1 is the maximum value of the score SC1 when the detected front image is not recognized as the front image of the object. When the score SC1 is larger than the threshold value T1, the normalization evaluator 25 determines that there is an object facing the front in the normalized image. When the score SC1 is equal to or smaller than the threshold value T1, the normalization evaluator 25 determines that there is no object facing the front in the normalized image. The normalization evaluator 25 outputs the determination result to the feature value extractor 26.

In such a manner, the normalization evaluator 25 can easily determine whether or not there is an object facing the front in the normalized image based on the comparison result between the score SC1 and the threshold value T1.

When it is determined that there is an object facing the front in the normalized image, the feature value extractor 26 extracts the feature value of the object from the normalized image. The feature value of the object means the amount of a feature that is not common to objects, but by which one object can be identified and another object can be rejected. The feature value of the object is, for example, a DCT (discrete cosine transform) feature value obtained by DCT transformation of the normalized image, or a Gabor feature value obtained by multiplying the normalized image by a Gabor filter of a different scale and direction.

The feature value extractor 26 outputs the extracted feature value to the identification unit 4. The feature value is extracted on the basis of the normalized image determined that there is an object facing the front. Therefore, the feature value faithfully reflects the feature of the object. By using such a feature value for authentication, an object can be authenticated with high accuracy.

The memory unit 3 has the feature value of the object facing the front stored therein as information used for authentication of the object. The memory unit 3 has feature values of a plurality of objects stored therein. The feature values of the objects stored in the memory unit 3 are of the type same as that of the feature value extracted by the feature value extractor 26 by sequentially using the object detector 22, the feature point detector 23, the normalizing unit 24, the normalization evaluator 25 and the feature value extractor 26. The feature value stored in the memory unit 3 is, for example, the DCT feature value or the Gabor feature value.

The identification unit 4 compares the extracted feature value of the object with the feature value stored in the memory unit 3. For example, the identification unit 4 identifies that the extracted object is an object detected from the memory unit 3 by detecting from the memory unit 3 an object having a feature value that matches with the extracted feature value.

(Example of Operation)

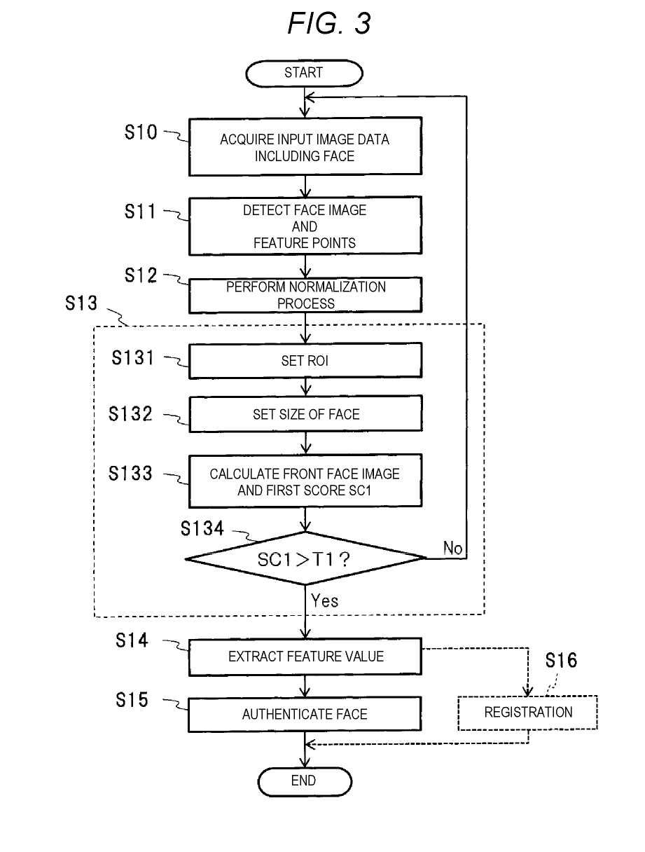

FIG. 3 is a flowchart showing an example of an operation of the authentication system 1 according to the first embodiment. Here, an example in which the object is a human face will be described. First, the image data acquisition unit 21 acquires input image data including a face (S10). Next, the object detector 22 detects the image of the face (hereinafter referred to as a face image) based on the input image data including the face acquired by the image data acquisition unit 21. Further, the feature point detector 23 detects several feature points of the face from the face image (S11).

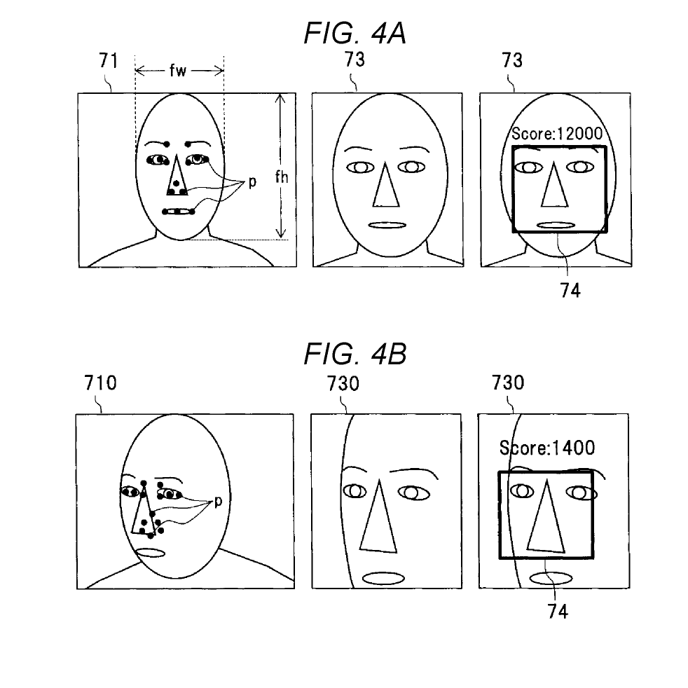

The face image is typically configured with a region between right and left eye corners and a region from a portion above eyebrows to the mouth. Assuming that the horizontal width of the face image is fw and the vertical width is fh (see FIG. 4A), the object detector 22 cuts out an image within the range of, for example, 2 fw×2 fh in the input image with respect to the center (cx, cy) of the face image. The object detector 22 outputs, to the feature point detector 23, an image that is obtained by further converting the cut-out image into an image having a predetermined size. By using an image larger than the face image as the detection result of the face image, a feature point that is not in the face image can also be detected.

For example, the feature point detector 23 detects, as the feature points of the face, for example, a total of 14 feature points: two points on the pupils, two points on the inner ends of the eyebrows, two points on the inner corners of the eyes, two points on the outer corners of the eyes, two points on the nostrils, one point on the nasal apex, two points on the mouth ends, and one point in the mouth.

Since each of the pupils and nostrils is almost in a circular shape, the feature point detector 23 may detect the feature points on each of the pupils and the nostrils using a circular separability filter. Corners including inner corners of the eyes, the outer corners of the eyes and the mouth ends may also be detected using a corner detection algorithm.

After the feature points are detected, the normalizing unit 24 performs a normalization process of the input image (S12). When the three-dimensional face shape model is used for the normalization process, the normalizing unit 24 linearly transforms the feature point positions on the three-dimensional face shape model and the 14 detected feature points to cause the input image to be fitted on the three-dimensional face shape model, and estimates the texture on the three-dimensional face shape model corresponding to the input image. Then, the normalizing unit 24 may rotate the three-dimensional face shape model and the texture to the front to generate a normalized image having a predetermined size.

At the time of authentication, the face orientation of an input image is often different from a face orientation registered in advance in the memory unit 3. Therefore, if the input image is used for face authentication as it is, erroneous authentication may occur or the authentication rate may decrease. In contrast, by performing the normalization process, input images of various face orientations can be converted so as to be in a predetermined direction and to have a predetermined size. This may reduce erroneous authentication and the decrease in the authentication rate.

However, the normalization process is not necessarily performed appropriately depending on the accuracy of the object detector 22 and the feature point detector 23. If the normalization process is inappropriate, erroneous authentication and the decrease in the authentication rate may still occur. In order to more surely reduce the erroneous authentication and the decrease in the authentication rate, after the normalization process, the normalization evaluator 25 determines whether or not there is a face facing the front with predetermined size (hereinafter referred to as a front face) in the normalized image (S13).

Specifically, the ROI setting unit 251 sets an ROI for the normalized image (S131). The ROI is a region in which there is a face in the normalized image. For example, the ROI setting unit 251 may set the ROI in the region with an area of one fourth at the center of the normalized image. In this case, since the region in which the face is projected can be designated while reducing the region used for determining whether there is the front face, the authentication accuracy can be maintained while increasing the processing speed.

Next, the detector setting unit 252 sets the maximum and minimum of the size of a face to be detected in pixels (S132). By setting the maximum and the minimum, the front detecting unit 253 can exclude a face projected larger than the maximum or smaller than the minimum from the detection target. In addition to the maximum and the minimum, the detector setting unit 252 determines a scale value and several sizes (layers) by which detection is specifically performed. For example, the maximum Max of the face size may be the same as the size of the ROI, and the minimum Min of the face size may be Min=Max/(Scale N). It is noted that Scale is a value larger than 1.0 and indicates a scale value between two layers of the detector. N indicates the number of layers detected by the detector.

Then, the front detecting unit 253 detects a front face image from the normalized image in the ROI, and calculates the score SC1 indicating the likelihood (S133). The dictionary data are used to detect the front image. The front detecting unit 253 outputs the position and size of the front image as the detection result of the front image. The score SC1 is set such that, with respect to the front image, the more the face faces the front, the larger the value, and the more the face faces obliquely, the smaller the value. In addition, the score SC1 is set such that the value of an image other than a face image is smaller than that of the face image.

For example, it is assumed that the value of the score SC1 is correlated with the Joint-Haarlike feature value. In this case, the more the face faces the front in the front image, the Haarlike feature value of each facial part tends to be “1” indicating that there is each facial part. In this case, the value of the Joint-Haarlike feature value is increased, and accordingly, the value of the score SC1 is also increased. On the other hand, the more the face faces obliquely in the front image, the Haarlike feature value of each facial part tends to be “0” indicating that there is no each facial part. In this case, the value of the Joint-Haarlike feature value is reduced, and accordingly, the value of the score SC1 is also reduced. Further, for an image other than a face image, the value of the Joint-Haarlike feature value becomes zero, and accordingly, the value of the score SC1 also becomes zero.

A specific application example of the score SC1 will be described below. FIG. 4A schematically illustrates an example of the calculation of a score when the normalization process is appropriate. When the face in an input image 71 faces the front, the feature point detector 23 detects a feature point p at a correct position on the facial part. By detecting the feature point p at the correct position, the normalizing unit 24 obtains a normalized image 73 including the front face. In this manner, the front detecting unit 253 calculates the score SC1 “12000” within the ROI 74 set by the ROI setting unit 251.

FIG. 4B schematically illustrates an example of the calculation of a score when the normalization process is inappropriate. When the face in an input image 710 faces obliquely, the feature point detector 23 detects a feature point p at an incorrect position on the facial part. By detecting the feature point p at the incorrect position, the normalizing unit 24 obtains a normalized image 730 including the face of which direction to the front is insufficient. In this manner, the front detecting unit 253 calculates the score SC1 “1400” within the ROI 74.

Subsequently, the score comparing unit 254 compares the score SC1 with the threshold value T1 (S134). When the score SC1 is larger than the threshold value T1 (S 134: Yes), the normalization evaluator 25 determines that there is a front face in the normalized image, and outputs the determination result to the feature value extractor 26. Then, the feature value extractor 26 extracts the feature value from the normalized image (S14). At the time of authentication, the identification unit 4 compares the extracted feature value with the feature value in the memory unit 3 to identify which of the faces registered in advance in the memory unit 3 corresponds to the face in the input image (S15).

On the other hand, when the score SC1 is equal to or less than the threshold value T1 (S134: No), the normalization evaluator 25 determines that there is no front face in the normalized image, and outputs the determination result to the image data acquisition unit 21. If there is no front face, the process returns to S10 where a new input image is acquired.

In the authentication system 1, the detected front image may be registered in the memory unit 3. The operation at the time of registration is the same as the operation at the time of authentication until “extract feature value” (S14) in FIG. 3. At the time of registration, the extracted feature value is registered in the memory unit 3 (S16).

The normalized image 73 in FIG. 4B has insufficient likelihood that the face faces the front and that the feature point is provided in the correct position of the facial part. When the normalized image is used for face authentication as it is, erroneous authentication and the decrease in authentication rate would occur.

In contrast, in the first embodiment, the normalization evaluator 25 evaluates the likelihood that there is a front face in the normalized image. Thus, a normalized image with low likelihood is rejected, and a normalized image with high likelihood can be used for face authentication. It is possible to reduce occurrence of erroneous authentication and the decrease in the authentication rate. Therefore, according to the first embodiment, an object can be appropriately authenticated.

As described above, in the first embodiment, the normalization evaluator 25 evaluates a normalized image, and when the normalized image is valid, the feature value extractor 26 extracts the feature value of an object. Alternatively, it may be determined whether to output the feature value extracted by the feature value extractor 26 to the identification unit 4, using the evaluation result of the normalization evaluator 25.

It is noted that, when a feature value is registered in the memory unit 3, the threshold value T1 may be set to be higher at the time of registration than that at the time of authentication. By setting the threshold value T1 at the time of registration to be higher, highly reliable dictionary data can be created.

### Second Embodiment

In a second embodiment, an ROI is set in a plurality of regions in which there should be feature points in the normalized image. It is noted that the same reference numerals are used for the configurations corresponding to the first embodiment, and redundant description is omitted.

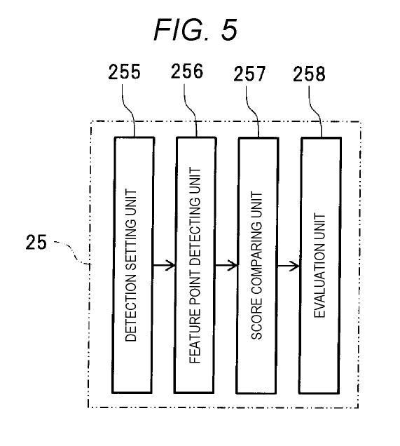

FIG. 5 is a block diagram of the normalization evaluator 25 according to the second embodiment. The normalization evaluator 25 of FIG. 5 includes a detection setting unit 255, a feature point detecting unit 256, a score comparing unit 257 and an evaluation unit 258.

The detection setting unit 255 sets an ROI in a plurality of regions in which there should be feature points in the normalized image. When the object is a face, the detection setting unit 255 may set an ROI in the regions including eyes, eyebrows, a nose, and a mouth, respectively. Further, the detection setting unit 255 sets the maximum and minimum sizes of the feature points to be detected depending on each of the ROIs. The setting may be made in pixels.

The feature point detecting unit 256 detects a feature point from each of the set ROIs, and calculates a score (second score, second value) SC2 indicating the likelihood of the feature point. The score SC2 indicates the likelihood that there is a feature point in the normalized image. The score SC2 is set such that the more the face faces the front, the larger the value.

The score comparing unit 257 compares the score SC2 corresponding to each of the ROIs with a threshold value (second threshold value) T2. The threshold value T2 is the maximum value of the score SC2 when the detected feature point is not recognized as the feature point of the object. When the score SC2 is larger than the threshold value T2, the detected feature point is recognized as a feature point of the object. It is noted that the threshold value T2 may be different for each ROI.

Based on the plurality of scores SC 2 corresponding to the respective ROIs, the evaluation unit 258 determines whether there is an object facing the front in the normalized image. For example, the evaluation unit 258 may calculate a total score SC2total obtained by aggregating the plurality of scores SC2, and determine whether there is an object facing the front based on whether or not the total score SC2total is greater than a total threshold value T2total. The total score SC2total may be a sum of the plurality of scores SC2. Alternatively, different weights may be set among the scores SC2 in the total score SC2total. Further, the total threshold value T2total may be the same as or different from the sum of the respective threshold values T2 for the scores SC2.

The normalization evaluator 25 can easily determine whether there is an object facing the front in the normalized image based on the score for each feature point.

(Example of Operation)

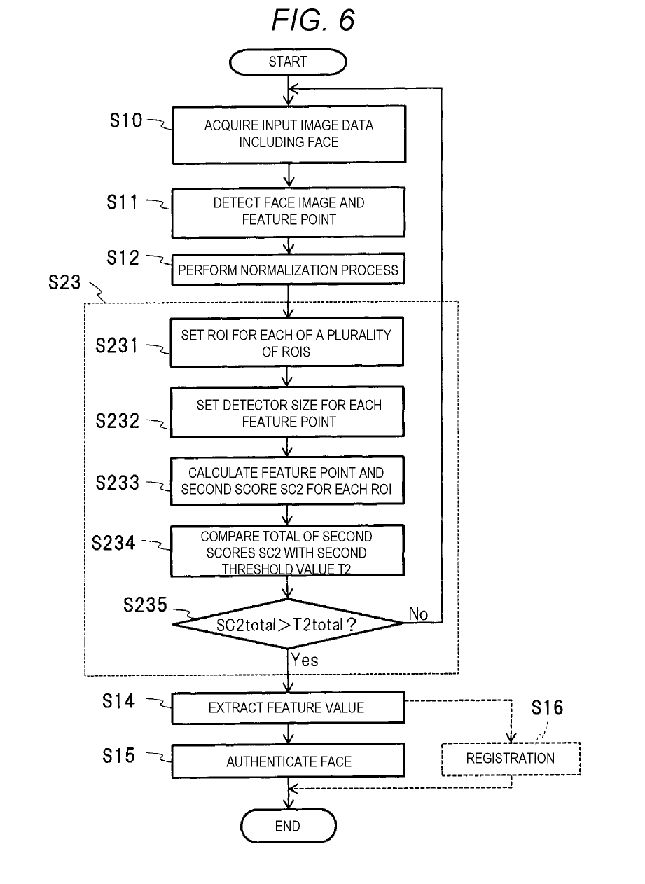

FIG. 6 is a flowchart showing an example of an operation of the authentication system 1 according to the second embodiment. The operation according to the second embodiment includes the step of S23 instead of S13 in the first embodiment. In the following, the determination as to whether there is a face facing the front carried out in S23 will be mainly described.

In S23, the detection setting unit 255 sets an ROI for each region where there should be a feature point (S231). In the face, for example, there is such a positional relationship that eyebrows are in the upper half of the face, both eyes are below the eyebrows, and there are nose and mouth under the eyes. Based on such a positional relationship and prekonwledge of size of each feature point, the detection setting unit 255 sets an ROI for each feature point, respectively.

Next, the detection setting unit 255 sets, for each feature point to be detected, the maximum and minimum of a feature point in pixels. That is, the detection setting unit 255 sets the detector size for each feature point (S232). For example, when detecting a pupil and a nostril as a circle, the detection setting unit 255 may set the radius of the circle to a value obtained by multiplying the size of the ROI of the pupil or the nostril by a predetermined magnification.

Next, for each ROI, the feature point detecting unit 256 detects a feature point, and calculates a score SC2 (S233). The dictionary data including learned feature points of the front image is used for feature point detection. The feature point detecting unit 256 outputs the position of a feature point as the detection result of the feature point. When the detected feature point is for a front face, the value of the score SC2 is high. When the detected feature point is for an oblique face, the value of the score SC2 is lower than that of the front face. When the detected feature point is not for a face, the value of the score SC2 is lower than that of the face image.

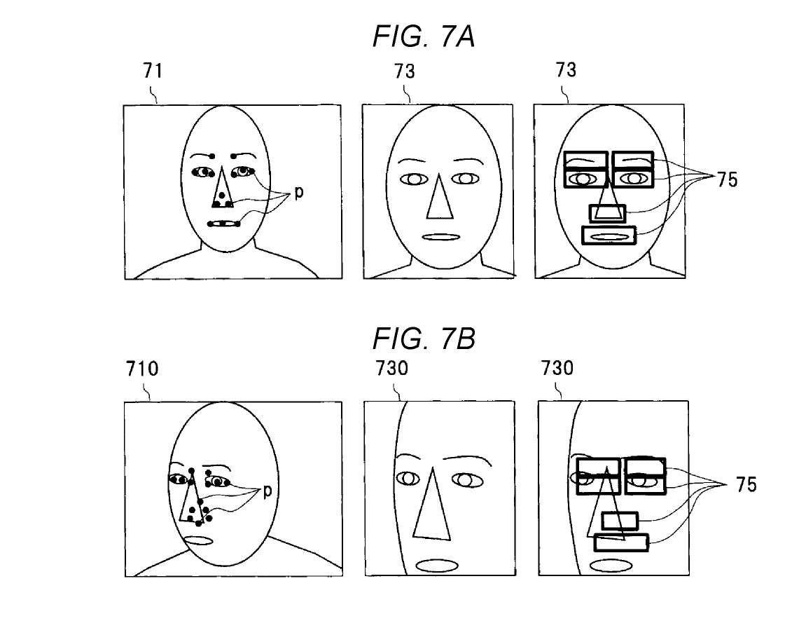

An example of detection of a feature point in the operation example of the face authentication system 1 according to the second embodiment will be described below. FIG. 7A schematically illustrates an example of the detection of a feature point when the normalization process is appropriate. When the face in the input image 71 faces the front, a feature point p is detected at a correct position on the facial part and the normalized image 73 including the front face is obtained. A plurality of ROIs 75 set for the normalized image 73 overlap the facial parts where there are feature points. Thus, in the ROI 75, a feature point with a higher score SC2 is detected.

FIG. 7B schematically illustrates an example of the detection of a feature point when the normalization process is inappropriate. When the face in the input image 710 faces obliquely, a feature point p is detected at an incorrect position on the facial part and the normalized image 730 including the oblique face is obtained. Then, the position of the facial part where there is the feature point shifts with respect to the ROI 75. Thus, in the ROI 75, a feature point with a lower score SC2 is detected.

Subsequently, the score comparing unit 257 compares the score SC2 with the threshold value T2, and outputs the comparison result to the evaluation unit 258 (S234).

The steps from S231 to S234 may be performed sequentially for a plurality of ROIs 75 or may be performed for a plurality of ROIs 75 at the same time.

The evaluation unit 258 determines whether there is a front face in the normalized image (S235). Specifically, the evaluation unit 258 determines whether there is a front face based on whether the total score SC2total is greater than the total threshold value T2total.

When the total score SC2total is greater than the total threshold value T2total (S235: Yes), the evaluation unit 258 determines that there is a front face. On the other hand, when the total score SC2total is equal to or less than the total threshold value T2total (S235: No), the evaluation unit 258 determines that there is no front face. If there is no front face, the process returns to S10 where a new input image is acquired.

In the second embodiment, whether or not there is a front face may be determined by comparing the total score SC2total with the total threshold value T2total by the evaluation unit 258. In this case, the score comparing unit 257 and its operation (S234) are omitted.

Also in the second embodiment, by the normalization evaluator 25 evaluating the normalized image, it is possible to use a normalized image with high likelihood that there is a front face for face authentication. In this manner, it is possible to appropriately perform face authentication while reducing erroneous authentication and the decrease in the authentication rate.

It is noted that when the total score SCtotal is calculated by adding up the scores SC2 of a plurality of feature points, each score SC2 of each feature point may be multiplied by a different weighted value. For example, the score of a pupil may be multiplied by a larger weight compared with the score of an eyebrow which is more likely to be hidden by a hat, or the score of a mouth or a nostril hidden by a mask. In this way, it is possible to improve the authentication rate even when a hat or a mask is worn.

### Third Embodiment

Next, a third embodiment for evaluating a normalized image generated based on each of feature point candidates will be described. It is noted that the same reference numerals are used for the configurations corresponding to the first embodiment, and redundant description is omitted.

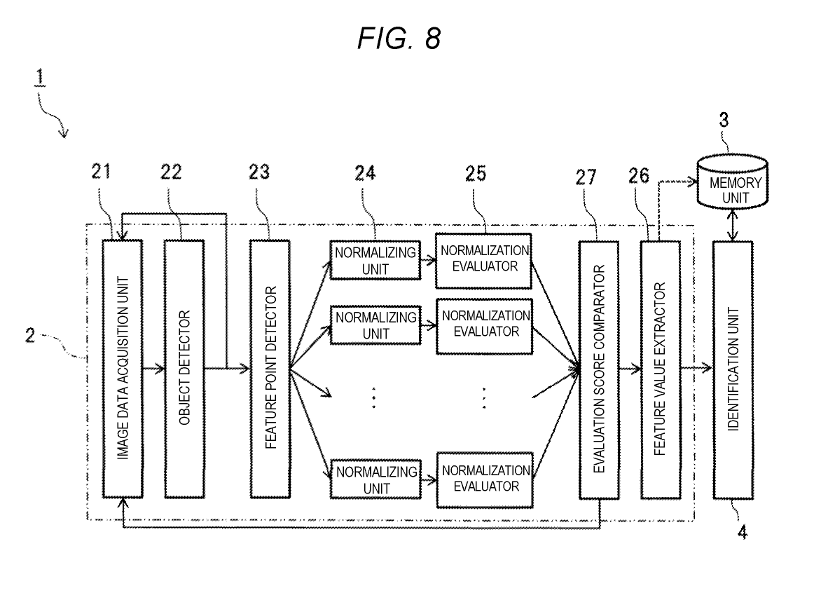

FIG. 8 is a block diagram of the authentication system 1 according to the third embodiment. The feature point detector 23 detects a plurality of feature point candidates. The term “feature point candidate” refers to a point that has not yet been determined to be a feature point. It is noted that in the case where an object has a plurality of feature points such as a face, there are a plurality of feature point candidates for each feature point. The feature point detector 23 detects a feature point candidate set combining feature point candidates. For example, when the number of facial parts of a human face is M, and the number of feature point candidates for each facial part is three, the feature point detector 23 detects 3̂ M of feature point candidate sets.

Further, the feature value extraction device 2 of the third embodiment includes a plurality of normalizing units 24, a plurality of normalization evaluators 25, and an evaluation score comparator 27. The number of normalizing units 24 is identical with the number of feature point candidate sets so that the normalizing units 24 correspond to the feature point candidate sets, respectively. Each normalizing unit 24 generates a normalized image based on the feature point candidate set. Generation of a normalized image based on a feature point candidate set may be performed by the same method as the generation of a normalized image based on a feature point.

The number of normalization evaluators 25 is identical with the number of normalizing units 24 so that the normalization evaluators 25 correspond to the normalizing units 24, respectively. Each of the normalization evaluators 25 determines whether or not there is an object facing the front in the corresponding normalized image. Each normalization evaluator 25 has a configuration similar to that illustrated in FIG. 2.

Each normalization evaluator 25 detects the front image included in the normalized image, and calculates a score (third score) SC3 indicating the likelihood thereof. When the detected score SC3 is larger than the threshold value T3, each normalization evaluator 25 determines that there is an object facing the front in the normalized image. The method of calculating the score SC3 may be the same as that of the first score SC1.

The evaluation score comparator 27 determines the normalized image having the maximum score SC3 among the normalized images determined that there is the object facing the front. The feature value extractor 26 extracts the feature value based on the normalized image determined by the evaluation score comparator 27.

(Example of Operation)

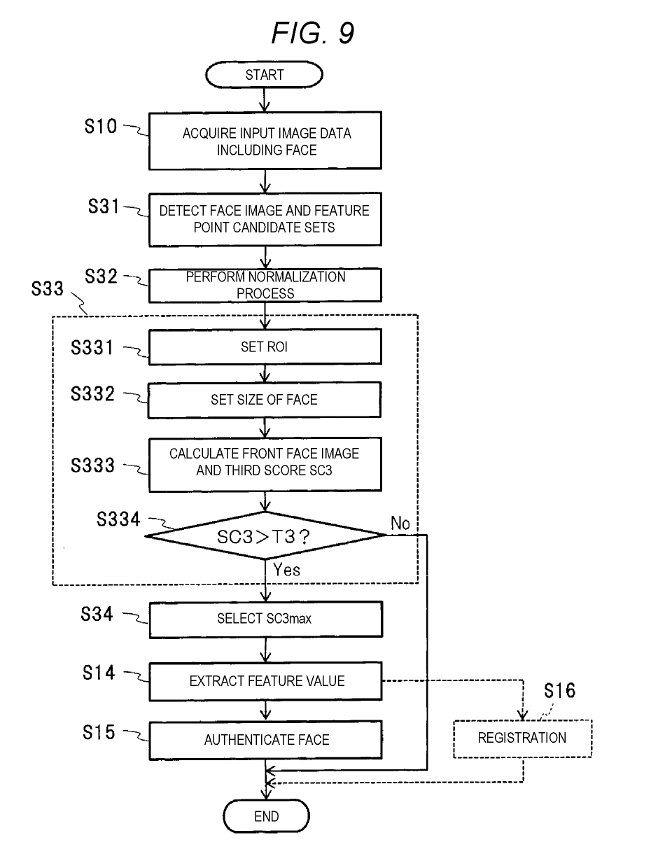

Next, an example of the operation when the object is a human face will be described. FIG. 9 is a flowchart showing an example of the operation of the face authentication system 1 according to the third embodiment.

First, the image data acquisition unit 21 acquires input image data including a face (S10). Then, the object detector 22 detects a face image based on the input image data. Further, the feature point detector 23 detects a plurality of feature point candidate sets based on the detected face image (S31). The feature point candidate sets are detected by using a circular separability filter or a corner detection algorithm, for example.

After the feature point candidate sets are detected, each normalizing unit 24 performs a normalization process of the input image based on the corresponding feature point candidate sets (S32). The normalization process based on the feature point candidate sets is performed using a three-dimensional face shape model expressed by feature point candidate positions and depth information in each feature point candidate, for example.

Subsequently, each normalization evaluator 25 determines whether or not there is a front face in the normalized image (S33). Specifically, first, the ROI setting unit 251 sets an ROI for the normalized image (S331). Next, the detector setting unit 252 sets the maximum and minimum of the size of a face to be detected in pixels (S332). Then, the front detecting unit 253 detects the front image from the normalized image within the range of the ROI, and calculates the score SC3 indicating the likelihood (S333). Subsequently, the score comparing unit 254 compares the score SC3 with the threshold value T3 (S334).

When the score SC3 is greater than the threshold value T3 (S334: Yes), the normalization evaluator 25 determines that there is a front face. On the other hand, when the score SC3 is equal to or less than the threshold value T3 (S334: No), the normalization evaluator 25 determines that there is no front face, and ends the process.

The evaluation score comparator 27 selects the maximum score SC3max among the scores SC3 larger than the threshold value T3 (S34). The evaluation score comparator 27 determines the feature point candidate corresponding to the score SC3max as a feature point. The feature value extractor 26 extracts the feature value of the normalized image having the score SC3max (S14).

Originally, feature point candidates are obtained in the process of calculation of feature points and are not used for the process after calculation of feature points. According to the third embodiment, by evaluating the normalized image based on a plurality of feature point candidates, the calculation result of the feature point candidates can be effectively used.

Also in the third embodiment, by the normalization evaluator 25 evaluating the normalized image, it is possible to use a normalized image with high likelihood that there is a front face for face authentication. In this manner, it is possible to appropriately perform face authentication while reducing occurrence of erroneous authentication and the decrease in the authentication rate.

(Variation)

Next, a variation of the third embodiment for setting ROIs for a plurality of regions in which there should be a feature point candidate in a normalized image generated based on each of feature point candidates will be described. The same reference numerals are used for the configurations corresponding to FIG. 8, and redundant description is omitted.

In the authentication system 1 of the variation, each normalization evaluator 25 has a configuration similar to that illustrated in FIG. 5. Specifically, each normalization evaluator 25 detects a feature point candidate set from each of the regions in which there should be the feature point candidate set in the normalized image, and calculates a score (fourth score) SC4 indicating the likelihood thereof. When the score SC4 is larger than the threshold value T4, each normalization evaluator 25 determines that there is an object facing the front in the normalized image. The method of calculating the fourth score SC4 may be the same as that of the second score SC2.

The evaluation score comparator 27 determines the normalized image having the maximum score SC4 among the normalized images determined that there is the object facing the front. The feature value extractor 26 extracts the feature value based on the normalized image determined by the evaluation score comparator 27.

(Example of Operation)

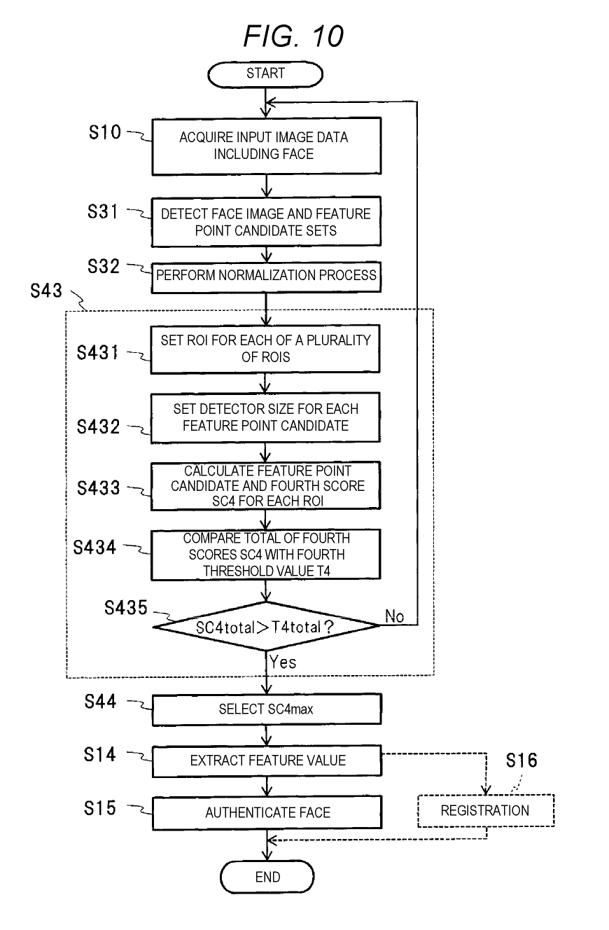

FIG. 10 is a flowchart showing an example of the operation of the face authentication system 1 according to the variation of the third embodiment. In the operation example of the authentication system 1 according to the variation, the determination as to whether there is a front face is different from S33 of FIG. 9. In the following, the determination as to whether there is a front face (S43) will be mainly described.

Specifically, each detection setting unit 255 sets an ROI for each region where there should be a feature point candidate (S431). Each detector setting unit 252 sets the detector size for each feature point candidate (S432). For each ROI, each feature point detecting unit 256 detects a feature point candidate with set size, and calculates a score SC4 indicating the likelihood thereof (S433). Each score comparing unit 257 compares the score SC4 with the threshold value T4 (S434). The score comparing unit 257 outputs the comparison result between the score SC4 and the threshold value T4 to the evaluation unit 258. The steps from S431 to S434 may be performed sequentially for a plurality of ROIs or may be performed for a plurality of ROIs at the same time.

Each evaluation unit 258 determines whether or not there is a front face in the corresponding normalized image (S435). Specifically, each evaluation unit 258 determines whether or not there is a front face based on whether or not the total score SC4total obtained by aggregating a plurality of scores SC4 is greater than the total threshold value T4total.

When the total score SC4total is greater than the total threshold value T4total (S435: Yes), the evaluation unit 258 determines that there is a front face. On the other hand, when the total score SC4total is equal to or less than the total threshold value T4total (S435: No), the evaluation unit 258 determines that there is no front face, and ends the process.

The evaluation score comparator 27 selects the maximum score SC4max among the total scores SC4total. The evaluation score comparator 27 determines the feature point candidate corresponding to the total score SC4max as a feature point. The feature value extractor 26 extracts the feature value of the normalized image having the total score SC4max.

It is noted that, in the fourth embodiment, since whether or not there is a front face may be determined by comparing the total score SC4total with the total threshold value T4total by the evaluation unit 258, the score comparing unit 257 and its operation (S434) may be omitted.

According to the variation, by the normalization evaluator 25 evaluating the normalized image, it is possible to use a normalized image with high likelihood that there is a front face for face authentication. In this manner, it is possible to appropriately perform face authentication while reducing erroneous authentication and the decrease in the authentication rate.

At least a part of the authentication system 1 of the embodiment may be configured by hardware or software. In the case of the software configuration, a software program that causes implementation of at least a part of the functions of the authentication system 1 may be stored in a non-transitory computer-readable medium such as a flexible disk or a CD-ROM and read by a computer for execution. The non-transitory computer-readable medium may be a detachable medium such as a magnetic disk and an optical disk, and may be a fixed-type medium such as a hard disk device or a memory.

Further, a software program causing implementation of at least a part of the functions of the authentication system 1 may be distributed via a communication line (including wireless communication) such as the Internet. Furthermore, the software program may be encrypted, modulated or compressed, and distributed via a wired line or a wireless line such as the Internet, or stored in a recording medium for distribution.

While certain embodiments have been described, these embodiments have been presented byway of example only, and are not intended to limit the scope of the inventions. Indeed, the embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method for carrying out a biometrics authentication, comprising:
detecting an object from a first image including the object;
detecting feature points of the object in the detected object;
generating a second image based on the feature points, wherein the second image is a normalized image of the object that is obtained by rotating and resizing the object in the first image;
determining whether or not the object in the second image faces front with predetermined size;
calculating a feature value of the object upon determining that the object in the normalized image faces front; and
comparing the calculated feature value with a reference feature value for the biometrics authentication.

2. The method according to claim 1, wherein determining whether or not the object in the second image faces front includes:
setting a region of interest in the second image, the region of interest including the feature points;
detecting a part of the object from the region of interest;
calculating a value for the detected part of the object, the value being greater when the detected part of the object faces front relative to when the detected part of the object faces an angled direction with respect to the front; and
determining whether or not the calculated value is greater than a threshold value, wherein the object is determined to face front when the calculated value is greater than the threshold value.

3. The method according to claim 2, wherein
the value correlates with a Joint-Haarlike feature value of the object in the second image, and increases as the Joint-Haarlike feature value increases.

4. The method according to claim 1, wherein determining whether or not the object in the second image faces front includes:
setting a plurality of regions of interest in the second image, each region of interest including at least one feature point;
detecting a part of the object from each of the regions of interest;
calculating a value for each of the detected parts of the object, the value being greater when the detected part of the object faces front relative to when the detected part of the object faces an angled direction with respect to the front;
calculating a total of the values; and
determining whether or not the calculated total is greater than a threshold value, wherein the object is determined to face front when the calculated total is greater than the threshold value.

5. The method according to claim 4, wherein
the value correlates with a Joint-Haarlike feature value of the object in the second image, and increases as the Joint-Haarlike feature value increases.

6. The method according to claim 1, wherein
the object is a human face, and
the feature points include points on each pupil, points on inner ends of eyebrows, points on inner ends of eyes, points on outer ends of the eyes, points on nostrils, a point on a nasal apex, points on mouth ends, and a point in a mouth.

7. The method according to claim 1, wherein
the feature value is one of a discrete cosine transform (DCT) feature value and a Gabor feature value.

8. A method for carrying out a biometrics authentication, comprising:
detecting an object from a first image including the object;
detecting a plurality of feature point candidates for each of feature points of the object in the detected object;
determining a plurality of groups of feature point candidates, each of which include one feature point candidate for each of the feature points;
generating a second image for each group of feature points candidates based on the feature points candidates in the group, wherein the second image is a normalized image of the object that is obtained by rotating and resizing the object in the first image;
determining whether or not the object in each of the second images faces front;
selecting one of the second images in which the object is determined to face front;
calculating a feature value of the object from the selected second image; and
comparing the calculated feature value with a reference feature value for the biometrics authentication.

9. The method according to claim 8, wherein determining whether or not the object in each of the second images faces front includes:
setting a region of interest in the second image, the region of interest including a group of the feature point candidates;
detecting a part of the object from the region of interest;
calculating a value for the detected part of the object, the value being greater when the detected part of the object faces front relative to when the detected part of the object faces an angled direction with respect to the front; and
determining whether or not the calculated value is greater than a threshold value, wherein the object is determined to face front when the calculated value is greater than the threshold value.

10. The method according to claim 9, wherein
the value correlates with a Joint-Haarlike feature value of the object in the second image, and increases as the Joint-Haarlike feature value increases.

11. The method according to claim 8, wherein determining whether or not the object in each of the second images faces front includes:
setting a plurality of regions of interest in the second image, each region of interest including at least one feature point candidate;
detecting a part of the object from each of the regions of interest;
calculating a value for each of the detected parts of the object, the value being greater when the detected part of the object faces front relative to when the detected part of the object faces an angled direction with respect to the front;
calculating a total of the values; and
determining whether or not the calculated total is greater than a threshold value, wherein the object is determined to face front when the calculated total is greater than the threshold value.

12. The method according to claim 11, wherein
the value correlates with a Joint-Haarlike feature value of the object in the second image, and increases as the Joint-Haarlike feature value increases.

13. The method according to claim 8, wherein
the object is a human face, and
the feature points include points on each pupil, points on inner ends of eyebrows, points on inner ends of eyes, points on outer ends of the eyes, points on nostrils, a point on a nasal apex, points on mouth ends, and a point in a mouth.

14. The method according to claim 8, wherein
the feature value is one of a discrete cosine transform (DCT) feature value and a Gabor feature value.

15. A non-transitory computer readable medium comprising a program that is executable in a computing device to cause the computing device system to perform a method for carrying out a biometrics authentication, the method comprising:
detecting an object from a first image including the object;
detecting feature points of the object in the detected object;
generating a second image based on the feature points, wherein the second image is a normalized image of the object that is obtained by rotating and resizing the object in the first image;
determining whether or not the object in the second image faces front;
calculating a feature value of the object upon determining that the object in the normalized image faces front; and
comparing the calculated feature value with a reference feature value for the biometrics authentication.

16. The non-transitory computer readable medium according to claim 15,
wherein determining whether or not the object in the second image faces front includes:
setting a region of interest in the second image, the region of interest including the feature points;
detecting a part of the object from the region of interest;
calculating a value for the detected part of the object, the value being greater when the detected part of the object faces front relative to when the detected part of the object faces an angled direction with respect to the front; and
determining whether or not the calculated value is greater than a threshold value, wherein the object is determined to face front when the calculated value is greater than the threshold value.

17. The non-transitory computer readable medium according to claim 16, wherein
the value correlates with a Joint-Haarlike feature value of the object in the second image, and increases as the Joint-Haarlike feature value increases.

18. The non-transitory computer readable medium according to claim 15,
wherein determining whether or not the object in the second image faces front includes:
setting a plurality of regions of interest in the second image, each region of interest including at least one feature point;
detecting a part of the object from each of the regions of interest;
calculating a value for each of the detected parts of the object, the value being greater when the detected part of the object faces front relative to when the detected part of the object faces an angled direction with respect to the front;
calculating a total of the values; and
determining whether or not the calculated total is greater than a threshold value, wherein the object is determined to face front when the calculated total is greater than the threshold value.

19. The non-transitory computer readable medium according to claim 18, wherein
the value correlates with a Joint-Haarlike feature value of the object in the second image, and increases as the Joint-Haarlike feature value increases.

20. The non-transitory computer readable medium according to claim 15, wherein
the object is a human face, and
the feature points include points on each pupil, points on inner ends of eyebrows, points on inner ends of eyes, points on outer ends of the eyes, points on nostrils, a point on a nasal apex, points on mouth ends, and a point in a mouth.
